(19) United States
(12) Patent Application Publication
(10) Pub. No.: US 2009/0138108 A1
(43) Pub. Date: May 28, 2009

(54) Method and System for Identification of Audio Input

(76) Inventors: Kok Keong Teo, Singapore (SG); Kok Seng Chong, Singapore (SG); Sua Hong Neo, Singapore (SG)

Correspondence Address: BAKER BOTTS L.L.P., 2001 ROSS AVENUE, SUITE 600, DALLAS, TX, 75201-2980, US

(21) Appl. No.: 11/571,493

(22) PCT Filed: Jul. 6, 2004
(86) PCT No.: PCT/SG2004/000198

§ 371 Date: Oct. 22, 2007

(51) Int. Cl. G06F 17/00

(52) U.S. Cl. 700/94

(57) ABSTRACT

A method for use in identifying an audio input, comprising the steps of: deriving a signature code from the audio input; subjecting the signature code to Correlation Matrix Memory (CMM) processing; and identifying the audio input based on an output of the CMM processing.

### CROSS-REFERENCE TO RELATED APPLICATION

This application claims priority to PCT/SG2004/000198, entitled Method and System for Identification of Audio Input, filed Jul. 6, 2004.

### TECHNICAL FIELD OF THE INVENTION

The present invention relates broadly to a method for use in identifying an audio input, to a method for producing a Correlation Matrix Memory (CMM) matrix, to a computer readable medium having stored thereon computer code means for instructing a computer to execute a method for use in identifying an audio input, and to a computer readable medium having stored thereon computer code means for instructing a computer to execute a method for producing a CMM matrix uniquely associated with one reference audio input.

### BACKGROUND OF THE INVENTION

Audio identification is a process of identifying music contents by extracting music features and comparing these features with a database of ‘fingerprints’. The input can be from file, real-time streaming, and real-time recording. The audio content is captured by a computer system to extract the feature. These features are transferred to the database system that contains a database of fingerprints. The features are matched with the fingerprints and the identification results are sent back to the computer system.

United States Patent Application No. 2002/0083060 A1 filed on 20 Apr. 2001 in the names of Avery et al relates to a method of recognising music signals in which a database index of a set of landmark time points and associated fingerprint is used to recognize an audio sample. Landmarks occur at reproducible locations within the file and fingerprints represent features of the signal at or near the landmark time points. Avery et al discloses the use of a pattern recognition process, which uses features of the audio itself from any sources such as radio, television broadcast or recording of playback over a speaker.

The method disclosed by Avery et al is disadvantageous in that it does involve the presence of artificial code or a watermark in the music signals.

It is with the knowledge of this disadvantage that the present invention has been made and has now been reduced to practice.

### SUMMARY OF THE INVENTION

In accordance with a first aspect of the present invention there is provided a method for use in identifying of an audio input, comprising the steps of deriving a signature code from the audio input, subjecting the signature code to Correlation Matrix Memory (CMM) processing; and identifying the audio input based on an output of the CMM processing.

The signature code may be segmented and encoded prior to being subjected to the CMM processing.

A segmentation step in the segmenting of the signature code of the audio input is larger than a segmentation step utilised in training of a CMM matrix uniquely associated with one reference audio input.

Deriving the signature code may comprise Fourier transforming overlapping frames of the audio input to form a plurality of frequency responses, dividing each frequency response into a series of bands, and generating the signature code based on a comparison of the energy differences in the bands of consecutive frequency responses.

The CMM processing may comprise subjecting the signature code to processing using different CMM matrices, wherein each CMM matrix is uniquely associated with one reference audio input.

The signature code to the CMM processing may comprise multiplying respective portions of the signature code with one CMM matrix for deriving a series of time codes.

The multiplying of the respective portions of the signature code with one CMM may produce a series of output codes, and each of the output codes is subjected to a threshold processing to produce the series of time codes.

The number of consecutive time codes in respective series of time codes derived utilising the different CMM matrices may be determined to reflect scores for the identification of the audio input.

The audio input may be identified as the reference audio input associated with the CMM matrix for which the highest score has been determined.

If no score has been determined after a predetermined portion of the signature code has been processed utilising one CMM matrix, the processing for said one CMM may be terminated, and the processing may continue with a different CMM.

The predetermined portion may be about 50% of the signature code.

In accordance with a second aspect of the present invention there is provided a method for producing a CMM matrix uniquely associated with one audio input, comprising the steps of deriving a signature code from the audio input; and training the CMM matrix such that a desired series of output codes is produced in multiplying portions of the signature code with the CMM matrix.

The series of output codes may comprise a series of consecutive time codes.

The signature code may be segmented and encoded prior to the portions being multiplied with the CMM matrix.

A segmentation step in the segmenting of the signature code of the audio input may be smaller than a segmentation step utilised in identifying a query audio input using the CMM matrix.

The deriving of the signature code may comprise Fourier transforming overlapping frames of the audio input to form a plurality of frequency responses, dividing each frequency response into a series of bands, and generating the signature code based on a comparison of the energy differences in the bands of consecutive frequency responses.

In accordance with a third aspect of the present invention there is provided a computer readable medium having stored thereon computer code means for instructing a computer to execute a method for use in identifying of an audio input, the method comprising the steps of deriving a signature code from the audio input, subjecting the signature code to CMM processing; and identifying the audio input based on an output of the CMM processing.

In accordance with a fourth aspect of the present invention there is provided a computer readable medium having stored thereon computer code means for instructing a computer to execute a method for producing a CMM matrix uniquely associated with one reference audio input, the method comprising the steps of deriving a signature code from the audio input; training the CMM matrix such that a desired series of time codes is produced in multiplying portions of the signature code with the CMM matrix.

In accordance with a fifth aspect of the present invention there is provided a system for identifying an audio input, the system comprising an input unit receiving the audio input; a processor unit for deriving a signature code from the audio input; a Correlation Matrix Memory (CMM) unit subjecting the signature code to CMM processing; and wherein the processor unit identifies the audio input based on an output of the CMM unit.

### BRIEF DESCRIPTION OF THE DRAWINGS

Embodiments of the invention are described hereinafter, by way of examples only, with reference to the drawings, in which:

FIGS. 1 a) to d) illustrate a CMM training process and the resultant CMM according to an embodiment of the present invention;

FIG. 2 illustrates a CMM recall process according to an embodiment of the present invention;

FIG. 3 illustrates the concept of time code according to an embodiment of the present invention;

FIG. 4 is a block diagram of the CMM training process according to an embodiment of the present invention;

FIG. 5 is a block diagram of the CMM identification process according to an embodiment of the present invention;

FIG. 6 is a flow chart of the CMM trainer according to an embodiment of the present invention;

FIG. 7 is a flow chart of the CMM Identifier according to an embodiment of the present invention;

FIG. 8 is a flow chart of the Forward function according to an embodiment of the present invention;

FIG. 9 is a flow chart of the Clean function according to an embodiment of the present invention;

FIG. 10 is a block diagram illustrating the operation of the forward function according to an. embodiment of the present invention;

FIG. 11 is a block diagram to show the operation of the clean function according to an embodiment of the present invention; and

FIG. 12 is a schematic drawing illustrating a computer system for implementing the method and system according to an embodiment of the present invention.

### DETAILED DESCRIPTION OF THE INVENTION

In an example embodiment, a correlation matrix memory is utilized as a form of memory to memorize the fingerprint of a song. One of the earliest associative neural memory models is the correlation matrix memory (CMM), also known as the linear associative memory. For this memory, the output for a given input key x is computed by the simple linear relation:

y=W·x

where W represents an N×M interconnections matrix.

The associative mapping is characterized by a simple matrix-vector multiplication. The question that immediately arises is how to obtain a matrix W such that the mapping can be best described. The CMM has a recording procedure and takes the form of Hebb's rules:

$$W = {\sum }_{n = 1}^{m} {{y}^{( u )} ( {x}^{( u )} )}^{T}$$

where x^{(u)} and y^{(u)} are column vectors representing the input and output patterns respectively. In the example embodiment, the input vectors are features extracted from the song. In the current embodiment, the output vectors are carefully configured to represent the time stamp of the song. This expression may be compacted in the following equation:

W=YX^{T}

where X represents an N×L matrix whose columns contain the input vectors and Y represents an M×L matrix whose columns contain the output vectors.

For computation efficiency, a binary CMM that has binary weights (0/1) and binary inputs are adapted in the example embodiment. This restriction results in a special case of the CMM that uses real-valued weights and inputs. The binary CMM matrix M is made up of an array of binary elements initially set to zero. The matrix is trained according to the values of the input and output vectors that are binary. Training involves forming the outer product between an input vector and an output i.e. bitwise Ored into the matrix. Subsequent patterns are incorporated in the same way resulting in an update to the matrix M.

The training process in the example embodiment is illustrated in FIGS. 1a) to d). The input vectors 100 are the audio feature extracted from the songs. The output vectors 102 are the time codes designed to represent the time stamp of the location of the audio feature. Therefore each CMM represents a song in the database that is used during the identification process. In each training step, e.g. FIG. 1a), and FIG. 1 b), newly trained associations are indicated as full circles, whereas previously trained associations in the CMM Matrix are indicated by empty circles. The trained associations correspond to “1” in the resulting CMM Matrix, as seen in FIG. 1c) and FIG. 1d).

In the ideal case, when relevant audio features are inputted into the corresponding CMM matrix, the CMM matrix will produce the respective time code in sequence. When irrelevant audio features are inputted into the CMM matrix, the CMM matrix will not produce any meaningful time code sequence. This is referred to as the recall process in the CMM. The recall process is similar to the training process except only the input vectors are presented. The columns are summed and the activation of the network threshold using the Wilshaw threshold to produce the output vectors. The Wilshaw threshold uses a fixed threshold that is typically derived from the number of bits set in the input vector (also known as the weight of the vector).

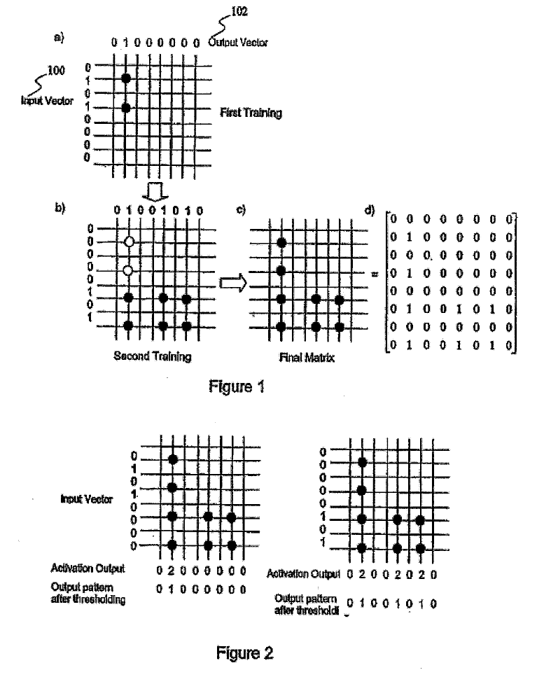

FIG. 2 illustrates the recall process using the trained matrix and input vector from the previous example. The threshold is set to the weight of the input vector that is 2 in this case.

The CMM model in the example embodiment may be used to memorise the fingerprint of a song. Each CMM serves to uniquely describe a particular song. To fully utilize the CMM to provide optimal storage performance, the system preferably satisfies the following conditions:
The input and output patterns are both sparse
The input patterns have equal weight
The input patterns are orthogonal

A typical audio feature does not satisfy the three criteria of itself, as the input patterns are random in nature. Time information is an important characteristic for audio data that is exploited in the example embodiment to gain good performance. The identification of Music system based on CMM (IM-CMM) in the example embodiment is designed to overcome the limitations and obtain optimal performance from the CMM.

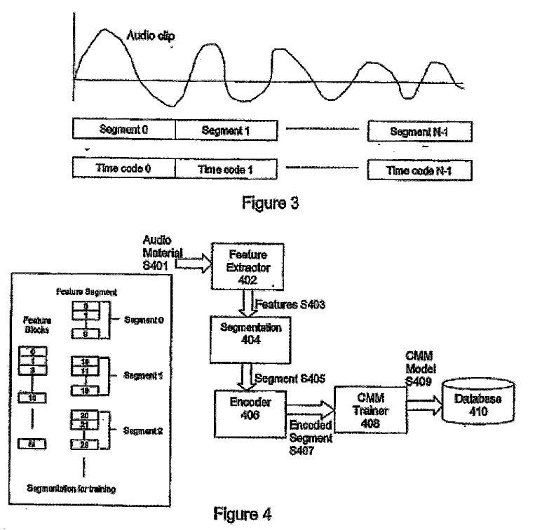

The first task is to process the audio feature into some sparse and equal weight patterns to obtain optimal performance from CMM. This process is referred to as the encoding scheme that is discussed in detail below. The choice of output pattern (y) determines the error computation method. This determines the ability of the system to detect the audio query (x), especially those with noise. A time code is a carefully designed pattern that serves as a time stamp of the song in the example embodiment. FIG. 3 illustrates the concept of time code that serves as a time stamp of song. The time code is shown in the table below:

| Segment number | Time Code |
|---|---|
| 0 | 1110000000-----------------------------0000 |
| 1 | 0111000000-----------------------------0000 |
| 2 | 0011100000-----------------------------0000 |
| N − 1 | 0000000000-----------------------------0111 |

The time code is made up of three consecutive ‘1’ and the rest of the bits are ‘0’. The length of the time code is N+2 bits where N is the total number of segments. For ease of implementation, N+2 may be rounded towards the next larger number that is divisible by 32 and is known as LEN. The excess bits may be set to zero. This helps to spread the input content across the matrix to gain maximum performance from the CMM. Consecutive segments have one bit shift to the right. This property allows for a similarity measure between the query and the fingerprint memorized by the CMM matrix. The similarity measure is defined as:

$$TSM = {\sum }_{i = 0}^{N} S ( TC ( i ) , TC ( i + 1 ) )$$

where TSM represents the total similarity measure, TC(i) is the time code at a particular time and i is the time index. The S(in1,in2) is the similarity measure that return 1 if the in2 is a right-shift of in1. This is referred to as a hit. Therefore TSM measures the total number of hits.

FIG. 4 illustrates the realization of the training method in the example embodiment. The audio material S401 is inputted into the feature extractor to produce the features S403. The feature S403 is segmented to produce non-overlapping segment of size 10. The encoder 406 encodes the segment to produce encoded segment S407. The encoded segment S407 is processed by the CMM trainer 408 to produce the CMM model 5409. The CMM model S409 may be stored in database 410 for further usage.

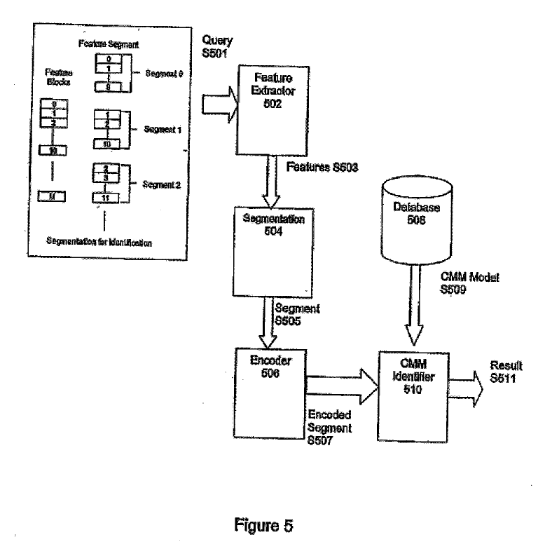

FIG. 5 illustrates the realization of the identification process in the example embodiment. The query audio S501 is inputted into the feature extractor 502. The feature S503 is produced and segmented by 504. The segmentation 504 divides the features into blocks of 10. This is to prevent time-shift during identification. The segment. S505 is processed by encoder 506 to produce the encoded segment S507. The CMM identifier 510 compares the encoded segment S507 and the CMM model S509 to produce the identification result. The identification result reflects the degree of match between the query and the song in the database 508. This process is repeated for all songs in the database 508. The song with the highest match is considered the identified song.

An embodiment of the Feature Extractor (402 and 502) process mentioned in FIG. 4 and FIG. 5 may be configured to produce features that are robust against distortions in the query, and will now be described.

The input audio is grouped into an overlapping frame that has a length of 16384 samples (approximately 0.4 seconds based on 44.1 KHz sampling frequency). A Hamming window with an overlap factor of 31/32 weights these frames. Each frame is transformed by Fourier Transform to produce the short-time frequency response. Each of these frequency responses is divided into 32 bands. The band's energies may then be compared with those of the previous frame. The band with energy greater than that of the previous frame will be coded as 1, otherwise the band will be coded as 0. In this way, a 32-bit code is generated which forms the signature code in the example embodiment.

It was verified experimentally that the sign of energy differences is a property that is very robust to many kinds of distortions. Lets denote the energy of band m of frame n by EB(n,m) and the m-th bit of the fingerprint H of frame n by H(n,m), the bits of the hash string are formally defined as:

$$H ( n , m ) = \{ \begin{matrix}1 \\ 0 \end{matrix} \begin{matrix}if EB ( n , m ) - EB ( n - 1 , m ) > 0 \\ if EB ( n , m ) - EB ( n - 1 , m ) \underline{<} 0\end{matrix}$$

The signature code of each song may be extracted and saved as the signature of the song.

Embodiments of the Segmentation (404 and 504) process will now be described. The process groups ten 32-bit words of the signature code together to form a segment. The segmentation 404 has a step of 10 that is illustrated in. FIG. 4. This will reduce the number of segments to be trained and in turn keep the matrix small. The segmentation process 504 of the identification process has a step of 1 as illustrated in FIG. 5. The identification process accepts audio query and there is no prior knowledge of which part of the song the query comes from. Therefore, there is likely to be some offset from the 10 steps boundary. Segmenting the query into steps of 1 does not significantly increase the retrieval time but provide robustness and accurate retrieval result.

In this embodiment, the segmentation process 404 stores the segments in a two dimensional buffer, input, to be accessed by other modules. The two-dimensional buffer is organized as shown below:

$$input •• = [ \begin{matrix}{c}_{0 , 0} & … & … & {c}_{0 , 9} \\ ⋮ & & & ⋮ \\ ⋮ & {c}_{nm} & & ⋮ \\ {c}_{N - 1 , 0} & … & … & {c}_{N - 1 , 9}\end{matrix} ]$$

Each row consists of 10 words that are used to store one segment such as c_{0,0} to c_{0,9}. Subsequent segments are stored in the rest of the rows according to their time sequence. The segmentation process 504 stored the query's segments in a two-dimensional buffer, code, to be accessed by other modules. The organization of the buffer code is identical to the buffer input.

An embodiment of an Encoder (406 and 506) is designed to produce output patterns that are sparse, equal weight and orthogonal and will now be described. The feature is a 32-bit signature code that was described above for the example embodiment. The 32-bit signature code is divided into items of two bits. Each item is encoded according to the table below:

| Item | Code |
|---|---|
| 00 | 1000 |
| 01 | 0100 |
| 10 | 0010 |
| 11 | 0001 |

Thus, every two bits in the input signature code are converted into a code with one bit set. Therefore the weight of the encoded pattern may be computed as:

w=N/2

where w is the weight of the encoded pattern and N is the number of bits of the input signature code.

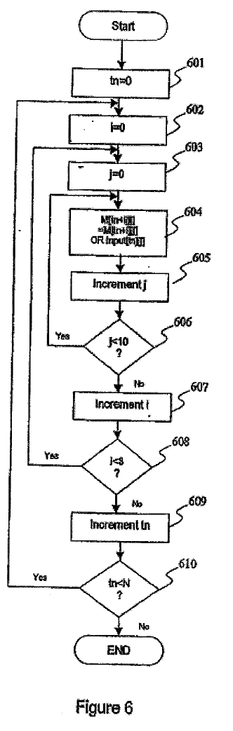

FIG. 6 shows the flow chart of the CMM trainer 408 of the example embodiment. It is given that there are only three consecutive bits that are for each output element (the time code). They are also only shifted one bit to the right for consecutive segment. These properties are used to speed up the training method. The algorithm performs a bitwise-OR operation on each row of the input with the corresponding row and the next two consecutive rows of the matrix M.

The first step is to initialize the indexes tn, i and jas shown in 601 to 603 respectively. The index to tracks the current location of the song being processed. The index i tracks the row offset from the current position of the two dimensional matrix, M. The index j tracks the column of the matrix M. The CMM matrix M is organized as shown below:

$$M •• = [ \begin{matrix}{a}_{0 , 0} & … & … & {a}_{0 , 9} \\ ⋮ & & & ⋮ \\ ⋮ & {a}_{y} & & ⋮ \\ {a}_{LEN - 1 , 0} & … & … & {a}_{LEN - 1 , 9}\end{matrix} ]$$

The process 604 bitwise-OR the data at tn row and j column of input array into the corresponding matrix location as shown in 604. The index j is incremented to move to the next column of the input array. This process is repeated until all columns are processed. This is decided by decision 606. When all columns are done, the index is incremented to point to the next row of matrix M. The processes 603 to 608 are repeated for three times. This is tested by decision 608. The index tn is incremented in process 609 to point to the next segment. The decision 610 tests whether all segments in the input array are processed.

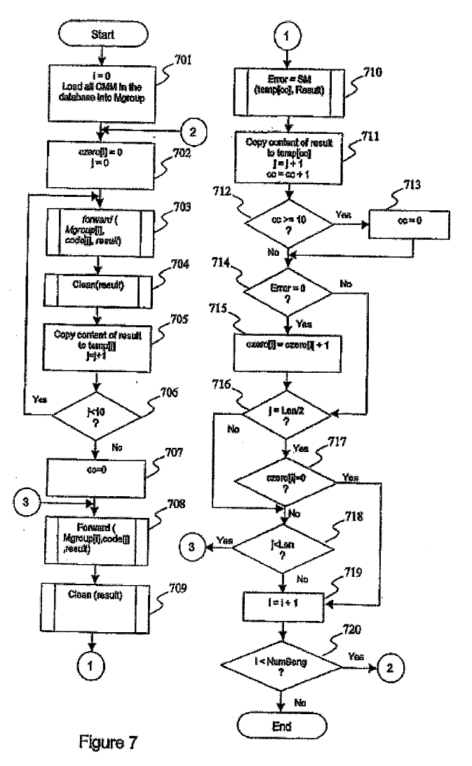

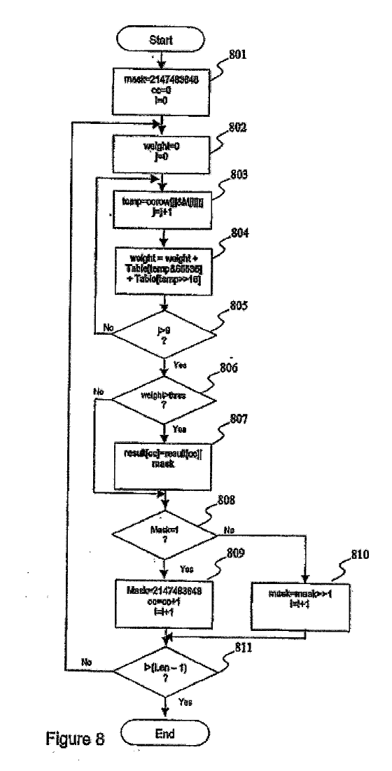

FIG. 7 shows the flow chart of the CMM identifier 510 in the example embodiment. The CMM identifier 510 computes the time code using the query segments and computes the hits. The hits are computed by accumulating the number of consecutive segment pairs that produce time codes that are only shifted by one bit to the right.

The process 701 initializes the index i to zero. It also loads all CMM matrices in the database into the memory. These matrices are loaded into a one-dimensional array known as Mgroup. Each of these matrices is a two-dimensional array. The index tracks the Mgroup to determine against which song is the query compared with. The process 702 initializes the parameter czero[i] and index j to zero. The czero is an one-dimensional array used to store the number of hits of songs against the query. The segmentation step of the training process is 10 while that of identification is 1. That is to say time code produced by segment 0 can only be compared with time code produced by segment 10. In this way, there is a meaningful comparison. Therefore, if the first ten time codes are generated and stored. The time code produced by the 10^{th} segment may be paired with the time code produced by the 0^{th} segment. This pair may then be tested for similarity.

The index j tracks the row of the two-dimensional array code. The two-dimensional array temp stores the last ten time codes produced. The process 703 computes the time code with the current CMM matrix indexed by i and the j-th element of the array code using the forward function. The buffer code is a two-dimensional array that stored segments of the query as shown below:

code[j]=└c_{j,0} . . . c_{j,9}┘

The output time code is contained in the data buffer result. The result array is cleaned for any stray ‘1’ using the clean function in 704. The content of result is copied to the two-dimensional array temp as shown in 705. The array temp is filled up with the first ten time codes produced. This is achieved by repeating processes 703 to 706 for 10 times and is tested by decision 706.

After producing the first ten time codes, the array temp is tracked by index cc to ensure that there is no buffer overflow. The process 707 initializes index cc to zero. The function forward is called again in process 708 to produce the respective time code. The time code produced is stored in array result and cleaned as shown in 709. The function SM (similarity measure) determines whether the time code pair temp[cc] and result is similar as shown in 710. Similarity in the example embodiment refers to the second time code being similar to the one-bit right-shifted version of the first time code. The content of result is copied to temp[cc] and the indexes cc and j are incremented as shown in 711. The index cc is tested whether it is greater than or equal to 10 as shown in decision 712. If cc is greater than or equal to 10, index cc is set to zero to prevent buffer overflow as shown in 713. The decision 714 determines whether the error is zero. If error is zero, it means that the time code pair under test is similar. Therefore, czero[i] is incremented to indicate that there is a hit for song i as shown in 715.

There is typically only one song in the database that the query is supposed to be matched to. That means that most of the time, the query is tested against invalid songs that in most cases do not produce any hit at all. This is exploited to improve the efficiency in the example embodiment. The decision 716 tests whether the processing has reached the mid-point of the query. If the processing is at the mid-point, the czero[i] is tested as shown in decision 717. If there is no hit yet, the current song is declared as invalid- and the system proceeds to the next song in the list. If there is at least one hit, the system continues to test whether all segments in the query are tested as shown in 718. The processes 708 to 718 are repeated until all segments in the query are tested as determined by decision 718. When all segments are completed, the index is incremented to point to next song in the Mgroup as shown in 719. The processes 702 to 720 are repeated until all songs in Mgroup are tested. The steps of advancing to the next song if czero[i] is zero at mid-point of the queries are optional if the processing speed of the system is very fast.

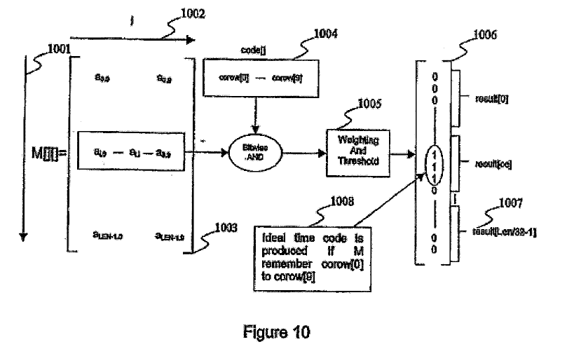

FIG. 10 illustrates the operation of the forward function in the example embodiment. The forward function is the recall process of the CMM described above. It is shown in 703 that the forward function receives two parameters from the identifier module. The forward function receives the two-dimensional array of CMM matrix under test and is represented by the parameter M in this function. The organization of the array M is illustrated in 1002. The forward function also receives the one-dimensional array of query segment under test and is represented by the parameter corow. The structure of the array corow is shown in 1004. The identifier module sends each row of the two-dimensional array code to the forward function. Each row represents the feature segment that is made up of ten 32-bit words of the signature code. The relationship between the array code and the array corow is illustrated below:

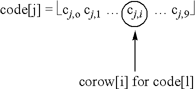

where c_{j,1} is the 32-bit signature code of the segment data obtained from the calling module.

Each row of array M is bitwise-AND with the array code. The bitwise-AND operation is performed word-by-word tracked by index j. The number of ‘1’ (also known as weight) of the result of the bitwise-AND operation is computed and thresholded as shown in 1005. The threshold is a step function where the output is a single bit. The output is ‘1’ for value greater than threshold; otherwise it is ‘0’. This operation is repeated for every row of the array M with the array code. The output bits are combined to form a binary string as shown in 1006. Therefore, there is LEN number of output bits. These output bits are stored in a one-dimensional array result that consists of 32-bit words. The array result is tracked by the index cc as shown in 1007.

FIG. 8 shows the flow chart of the forward function 703 as described above. The process 801 initializes the index cc to zero. The parameter mask is a 32-bit word and its most significant bit is set to ‘1’ as shown in 801. The parameter mask sets the corresponding output bit ‘1’ when the weight is greater than the threshold. The process 802 initializes the parameters weight and j to zero. The parameter weight stores the accumulative output of the weighting process 1005. The corow[l] is bitwise-AND with the CMM matrix M[i][j] to produce raw pattern temp as shown in 803.

The process 804 is the realization of the weighting process 1005 in the example embodiment. To improve efficiency, a 2¹⁶-lookup table, Table, is used to compute the number of ‘1’ bits in the temp. The array Table contains the information on the number of ‘1’ bits of any 16-bit number. Therefore, the parameter temp is split into two 16-bit words. The lower 16 bits of the parameter temp are obtained by bitwise-AND with 65535. The magic number 65535 has all lower 16 bits set to ‘1’. The parameter temp is also shifted to right by 16 bits to obtain the upper 16 bits. These two words may be used as an index in the array Table to obtain the number of ‘1’ in the respective word. The sum of the numbers of bits of the two words is the accumulative weight of the pattern temp. The above-mentioned processes are shown in 804. The processes 803 to 805 are repeated until all elements of row i of the matrix M are computed. This is tested by decision 805.

The weight is compared with a threshold as shown in decision 806. If the weight is greater than the threshold, the result[cc] is bitwise-OR with the mask as shown in 807 to set the respective bit to ‘1’. The mask is tested whether it is equal to 1 as shown in decision 808. If the result is true, it means that the least significant bit of result[cc] has been tested. Therefore, the next word in the array result has to be utilized. To achieve this, the mask is reinitialized by setting its most significant bit to ‘1’ and the indexes, cc and i are incremented as shown in 809. If the mask is not equal to 1, there are still unutilized bits left in the 32-bit word result[cc]. Therefore, the mask is shifted to the right by one bit and index 1 is incremented as shown in 810. The processes 802 to 811 are repeated until all rows of the matrix M are processed as tested by decision 811.

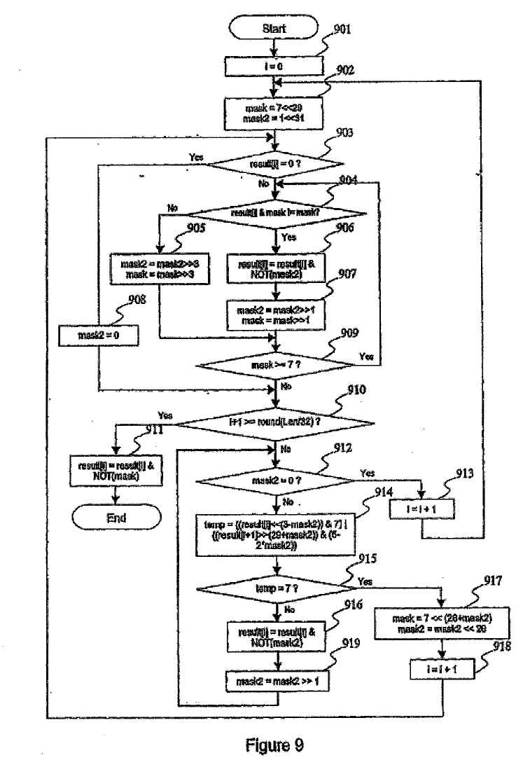

FIG. 9 shows the flow chart of the clean function 709 in the example embodiment. The clean function 709 receives a one-dimensional array result from the calling function. This array contains the output from the forward function that most likely will contain stray ‘1’ bits due to noise in the query. The purpose of the clean function is to clean up these stray ‘1’ bits so that the similarity measure function may be executed.

The process 901 initializes the index i to zero. The process 902 initializes the parameters mask and mask2 to 7<<29 (i.e. three most significant bits are set to ‘1’) and 1<<31 (i.e. most significant bit is set to ‘1’) respectively. The array result contains the bit pattern to be cleaned by this function. The decision 903 tests whether the result[i] is zero. If the result[i] is zero, no cleaning is required and the next word in array result will be processed via processes 908, 910, 912 and 913. It is understood that only three consecutive ‘1’ bits are considered as valid whereas the other combinations are treated as stray ‘1’.

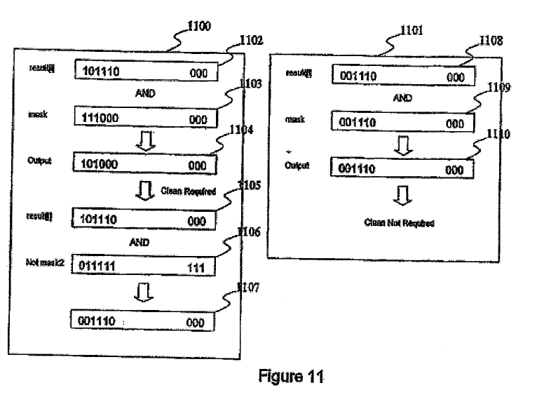

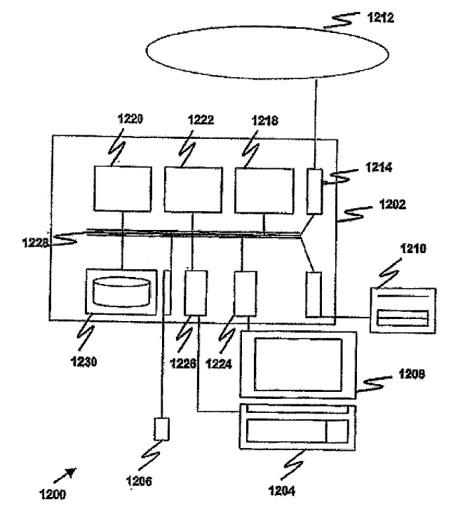

There are two possibilities in the example embodiment that are illustrated in FIG. 11. The result[i] in 1102 contains a stray ‘1’ in the first bit as well as the valid three consecutive ‘1’ bits. Therefore, the clean function has to clear the first bit to zero while preserving the three consecutive ‘1’ bits. The result[i] is bitwise-AND with the mask 1103 to test only the first three bits. This is tested by decision 904. The output of the operation is shown in 1104 that is not equal to the mask. It means that there are no three consecutive ‘1’ bits, instead a stray bit is present. The result[i] 1105 is bitwise-AND with the 1^{st} complement of the mask2. The first bit is clear to zero while the rest of the bits are left untouched as shown in 1107. This operation is shown in 906. The parameters mask2 and mask are shifted one bit to the right as shown in 907 to test the next three bits. The example 1101 illustrates the case when there are three consecutive ‘1’ bits. The result[i] is bitwise-AND with the mask to produce the output 1110. The output is equal to the mask. Therefore, three consecutive ‘1’ are detected. The parameters mask2 and mask are shifted 3 bits to the right to test the next three bits as shown in 905. The processes 904 to 907 and 909 are repeated until mask is less than 7 as tested by decision 909. This means that mask2 can be of value 2, 1 or 0. The mask2 is checked by decision 912. If mask2 is 0, it indicates that result[i] has been completely processed. The index i is incremented as shown in 913 to point to the next word in the array result. The processes 902 to 910 and 912 to 913 are repeated until all the words in the array result have been processed. If mask2 is 2 or 1, it indicates that the last two bits or one bit of result[i] have not been processed yet. In this case, these remaining bits will be processed by concatenating them with the most significant bits from the next word in array result to form three consecutive bits in process 914. These three consecutive bits are checked in decision 915 for bit pattern ‘111’. If the result is true, both mask and mask2 will be adjusted to point to the correct starting position in the next word in array result in process 917. The index i is then incremented in process 918 to point to the next word in the array result and the processing is repeated starting from decision 903. If the result is false, the bit pointed by mask2 in result[i] will be set to ‘0’ in process 916. The mask2 is then shifted one bit to the right in process 919. The processing loop (912, 914 to 916 and 919) is repeated until mask2 is 0 (i.e. all bits in results have been completely processed). If result[i] is tested as the last word in the array result in decision 910, any remaining bits in result[i] will be set to ‘0’ in process 911.

The method and system of the example embodiment may be implemented on a computer system 1200, schematically shown in FIG. 12. The methods may be implemented as software, such as a computer program being executed within the computer system 1200, and instructing the computer system 1200 to conduct the method of the example embodiment.

The computer system 1200 comprises a computer module 1202, input modules such as a keyboard 1204 and mouse 1206 and a plurality of output devices such as a display 1208, and printer 1210.

The computer module 1202 is connected to a computer network 1212 via a suitable transceiver device 1214, to enable access to e.g. the Internet or other network systems such as Local Area Network (LAN) or Wide Area Network (WAN).

The computer module 1202 in the example includes a processor 1218, a Random Access Memory (RAM) 1220 and a Read Only Memory (ROM) 1222. The computer module 1202 also includes a number of Input/Output (I/O) interfaces, for example I/O interface 1224 to the display 1208, and I/O interface 1226 to the keyboard 1204.

The components of the computer module 1202 typically communicate via an interconnected bus 1228 and in a manner known to the person skilled in the relevant art.

The application program is typically supplied to the user of the computer system 1200 encoded on a data storage medium such as a CD-ROM or floppy disk

1. A method for use in identifying an audio input, comprising the steps of:
deriving a signature code from the audio input;
subjecting the signature code to Correlation Matrix Memory (CMM) processing; and
identifying the audio input based on an output of the CMM processing.

2. The method as claimed in claim 1, wherein the signature code is segmented and encoded prior to being subjected to the CMM processing.

3. The method as claimed in claim 2, wherein a segmentation step in the segmenting of the signature code of the audio input is smaller than a segmentation step utilised in training of a CMM matrix uniquely associated with one reference audio input.

4. The method as claimed in claim 1, wherein deriving the signature code comprises Fourier transforming overlapping frames of the audio input to form a plurality of frequency responses, dividing each frequency response into a series of bands, and generating the signature code based on a comparison of the energy differences in the bands of consecutive frequency responses.

5. The method as claimed in claim 1, wherein the CMM processing comprises subjecting the signature code to processing using different CMM matrices, wherein each CMM matrix is uniquely associated with one reference audio input.

6. The method as claimed in claim 5, wherein subjecting the signature code to the CMM processing comprises multiplying respective portions of the signature code with one CMM matrix for deriving a series of time codes.

7. The method as claimed in claim 6, wherein the multiplying of the respective portions of the signature code with one CMM matrix produces a series of output codes, and each of the output codes is subjected to a threshold processing to produce the series of time codes.

8. The method as claimed in claim 6, wherein the number of consecutive time codes in respective series of time codes derived utilising the different CMM matrices are determined to reflect scores for the identification of the audio input.

9. The method as claimed in claim 8, wherein the audio input is identified as the reference audio input associated with the CMM matrix for which the highest score has been determined.

10. The method as claimed in claim 8, wherein, if no score has been determined after a predetermined portion of the signature code has been processed utilising one CMM matrix, the processing for said one CMM matrix is terminated, and the processing continues with a different CMM matrix.

11. The method as claimed in claim 10, wherein the predetermined portion is about 50% of the signature code.

12. A method for producing a CMM matrix uniquely associated with one reference audio input, comprising the steps of:
deriving a signature code from the audio input;
training the CMM matrix such that a desired series, of time codes is produced in multiplying portions of the signature code with the CMM matrix.

13. The method as claimed in claim 12, wherein the series of output codes comprises a series of consecutive time codes.

14. The method as claimed in claim 12, wherein the signature code is segmented and encoded prior to the portions being multiplied with the CMM matrix.

15. The method as claimed in claim 14, wherein a segmentation step in the segmenting of the signature code of the audio input is larger than a segmentation step utilised in identifying a query audio input using the CMM matrix.

16. The method as claimed in claim 12, wherein the deriving of the signature code comprises Fourier transforming overlapping frames of the audio input to form a plurality of frequency responses, dividing each frequency response into a series of bands, and generating the signature code based on a comparison of the energy differences in the bands of consecutive frequency responses.

17. A computer readable medium having stored thereon computer code for instructing a computer to identify an audio input, the code operable to:
derive a signature code from the audio input;
subject the signature code to a CMM processing; and
identify the audio input based on an output of the CMM processing.

18. A computer readable medium having stored thereon computer code for instructing a computer to produce a CMM matrix uniquely associated with one reference audio input, the code operable to:
derive a signature code from the audio input;
train the CMM matrix such that a desired series of time codes is produced in multiplying portions of the signature code with the CMM matrix.

19. A system for identifying an audio input, the system comprising:
an input unit receiving the audio input;
a processor unit for deriving a signature code from the audio input;
a Correlation Matrix Memory (CMM) unit subjecting the signature code to CMM processing; and
wherein the processor unit identifies the audio input based on an output of the CMM unit.
